(19) United States
(12) Patent Application Publication
(10) Pub. No.: US 2012/0032513 A1
(43) Pub. Date: Feb. 9, 2012

(54) BATTERY MANAGEMENT CIRCUIT, BATTERY MODULE AND BATTERY MANAGEMENT METHOD

(75) Inventors: ROBERT Y.H. TSU, Taichung City (TW); CHING LONG LIN, Taipei City (TW)

(73) Assignee: ENERGY PASS, INC., Hsinchu City (TW)

(21) Appl. No.: 13/197,821

(22) Filed: Aug. 4, 2011

Related U.S. Application Data
(60) Provisional application No. 61/371,264, filed on Aug. 6, 2010.

(30) Foreign Application Priority Data
Sep. 29, 2010 (TW) 99133140

(51) Int. Cl. H02J 1/10; H02J 9/00; H01H 47/00

(52) U.S. Cl. 307/43; 307/113; 307/65; 307/130

(57) ABSTRACT

A battery management circuit, a battery module and a battery management method are provided. The battery management circuit includes a conduction circuit and a control circuit. The battery management is coupled to a rechargeable battery cell and has a first conduction path passing through the rechargeable battery cell and a second conduction path without passing through the rechargeable battery cell. The control circuit is coupled to the rechargeable battery cell and the conduction circuit, and conducts selectively the first conduction path or the second conduction path of the conduction circuit so as to avoid over charging or over discharging of the rechargeable battery cell.

### BACKGROUND OF THE INVENTION

1. Field of the Invention

The present invention relates an electric power management circuit, and more particularly, to a cell level battery management circuit, an array battery management circuit and a battery module.

2. Description of Related Art

In general, a battery, also called a cell, is consisted of a plurality of cells connected in series or in parallel, with lead-acid batteries being the most common used ones. Batteries can be divided into general battery (primary battery) and rechargeable battery (or called secondary battery). The general battery generally can not be recharged after the general battery is run out of power. While the rechargeable battery, such as Lithium-ion batteries, nickel-iron batteries, lead acid batteries, nickel cadmium batteries, nickel metal hydride battery, can be recharged after the battery is run out of power.

Since the rechargeable battery has memory effect, with the nickel-cadmium battery being the worst, the battery would be damaged if overcharging or over-discharging occurs. One battery set usually includes a plurality of cells; each cell has slightly different charging and discharging characteristics. Some cells may be damaged if using the same voltage to charge all the cells. In contrast, during discharging, some cells of the battery set may be damaged due to over-discharging.

In related arts, the power management is very important to the rechargeable battery. However, in most current management techniques, the cells are managed as a set rather than being managed individually, which result in lower charging/discharging efficiency, and during charging or discharging, the cells may be easily damaged due to overcharging or over-discharging.

### SUMMARY OF THE INVENTION

The present disclosure provides a battery management circuit which is capable of monitoring the states of charge of a plurality of cells (rechargeable battery) and preventing each rechargeable battery from being overcharged or over-discharged, and therefore increasing the power efficiency and extending the lifetime of the rechargeable battery.

The present disclosure further provides a battery module which monitors the individual rechargeable battery through an array controller. The battery module may adjust the charging/discharge paths to skip the problematic rechargeable battery and prevents the individual rechargeable battery from being overcharged or over-discharged, therefore increasing the power efficiency and lifetime of the battery sets.

The present disclosure also provides a battery management method which is capable of directly monitoring the states of charge of all the rechargeable batteries and protecting the rechargeable batteries from damage by controlling the charging/discharging paths of the rechargeable batteries. Additionally, the method may also collect the states of charge of the individual rechargeable battery, such as charging/discharging efficiency or remaining electric power thereof.

The present disclosure further provides a battery module. There is a backup battery set added in the battery module, thereby extending the lifetime of battery module and preventing a single battery set form the damage and avoiding affecting the overall power output of the battery module.

The present disclosure is directed to a battery management circuit suitable for a rechargeable battery, comprising: a conduction circuit coupled to the rechargeable battery, the conduction circuit having a first conduction path passing through the rechargeable battery and a second conduction path without passing through the rechargeable battery; and a control circuit coupled to the rechargeable battery and the conduction circuit for selectively conducting the first conduction path or the second conduction path of the conduction circuit according to a battery voltage of the rechargeable battery.

According to one embodiment of the disclosure, when the battery voltage of the rechargeable battery is greater than a first threshold value, the conduction circuit conducts the second conduction path and turns off the first conduction path. When the battery voltage of the rechargeable battery is less than a second threshold value, the conduction circuit conducts the second conduction path and turns off the first conduction path. When the battery voltage of the rechargeable battery is less than the first threshold value and greater than the second threshold value, the conduction circuit conducts the first conduction path and turns off the second conduction path, wherein the first threshold value is greater than the second threshold value.

According to one embodiment of the disclosure, the conduction circuit comprises: a first switch coupled to a positive electrode of the rechargeable battery and a first terminal; a second switch coupled to a negative electrode of the rechargeable battery and a second terminal; and a third switch coupled to the first terminal and the second terminal; wherein when the battery voltage of the rechargeable battery is greater than a first threshold value, the conduction circuit conducts the third switch but turns off the first switch and the second switch; when the battery voltage of the rechargeable battery is less than a second threshold value, the conduction circuit conducts the third switch and turns off the first switch and the second switch; when the battery voltage of the rechargeable battery is less than the first threshold value and greater than the second threshold value, the conduction circuit conducts the first switch and the second switch and turns off the third switch.

According to one embodiment of the disclosure, the control circuit comprises: a voltage sensing unit coupled to a positive electrode and a negative electrode of the rechargeable battery for sensing the battery voltage of the rechargeable battery; a control unit coupled to the voltage sensing unit and the conduction circuit for controlling the conduction circuit to conduct the first conduction path or the second conduction path according to the battery voltage of the rechargeable battery, wherein the control circuit further comprises a current sensing unit coupled to the rechargeable battery and the control unit for sensing a current value flowing through the rechargeable battery; wherein the control unit calculates a state of charge of the rechargeable battery according to the battery voltage and the current value flowing through the rechargeable battery.

The present disclosure further provides a battery module which includes a plurality of power units and an array controller. Each power unit has a rechargeable battery. The array controller has a plurality of channels coupled to the power units respectively. The array controller respectively detects the states of charge of the rechargeable batteries through the channels and respectively controls the charge/discharge paths of the rechargeable battery according to the states of charge of the rechargeable batteries.

The present disclosure further provides a battery module which comprises a plurality of battery sets, each battery set having a plurality of rechargeable batteries; a backup battery set having a plurality of rechargeable batteries; a power path circuit coupled to the battery sets and the backup battery set for switching conduction paths of the battery sets and the backup battery set; a voltage sensing unit coupled to the power path circuit for sensing whether or not the battery voltages of the battery sets are normal; and a controller coupled to the voltage sensing unit and the power path circuit. Wherein the controller determines whether or not the battery sets are damaged according to a sense result from the voltage sensing unit, when one of the battery sets is damaged, the controller adjusts the conduction paths of the battery sets and the backup battery set through the power path circuit to replace the damaged battery set with the backup battery set.

The present disclosure further provides a battery management method including the following steps: (a) providing a plurality of channels respectively coupled to a plurality of power units having a rechargeable battery respectively; (b) respectively detecting states of charge of the rechargeable batteries through the channels; and (c) respectively controlling the charge/discharge paths of the rechargeable batteries according to the states of charge of the rechargeable batteries.

In summary, by the battery management circuit in the present disclosure, the problems resulting in damage of the individual cell due to overcharging or over-discharging the cell are solved. The present disclosure also has the following benefits: (1) monitoring the states of charge of the individual cell to prevent the cell from being overcharged or over-discharged; (2) the array controller is able to monitor the states of charge of all the cells, and thus providing the most accurate power consumption statuses; (3) the backup battery set is able to replace the damaged battery set and thus increase the lifetime of the battery module and prevent the electric power output of the battery module from being affected due to the damage of a single cell.

In order to have further understanding of the present invention, the following embodiments are provided along with illustrations to facilitate the disclosure of the present invention.

### BRIEF DESCRIPTION OF THE DRAWINGS

FIG. 1 shows schematic diagram of a battery management according to the first embodiment of the present disclosure;

FIG. 2 shows a schematic diagram of a battery module according to the first embodiment of the present disclosure;

FIG. 3 shows a schematic diagram of a battery module according to a second embodiment of the present disclosure; and

FIG. 4, which shows a flow chart of battery management method according to a third embodiment of the present disclosure.

### DETAILED DESCRIPTION OF THE PREFERRED EMBODIMENTS

In the paragraphs below, figures will be referenced to explain different embodiments of the instant disclosure in details. For identical parts, same numbers are used in different figures for illustrations.

### First Embodiment

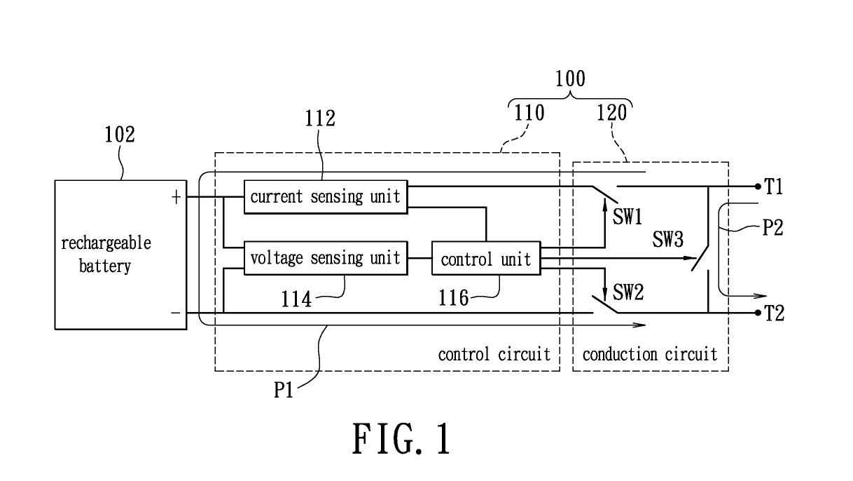

FIG. 1 shows schematic diagram of a battery management according to the first embodiment of the present disclosure. The battery management circuit 100 is suitable for managing the charge/discharge procedures of a rechargeable battery 102. The battery management circuit 100 includes a control circuit 110 and a conduction circuit 120. The control circuit 110 is coupled to the conduction circuit 120 and a rechargeable battery 102. The conduction circuit 120 is coupled to a positive electrode and a negative electrode of the rechargeable battery 102. The control circuit 110 includes a current sensing unit 112, a voltage sensing unit 114 and a control unit 116, wherein the current sensing unit 112 is coupled to the positive electrode of the rechargeable battery 102 for sensing a current value flowing through the rechargeable battery 102, and the voltage sensing unit 114 is coupled to the positive and negative electrodes of the rechargeable battery 102 for sensing the battery voltage of the rechargeable battery 102. The control unit 116 is coupled to the current sensing unit 112, the voltage sensing unit 114 and the conduction circuit 120. The control unit 116 may control the conduction circuit 120 to form a corresponding conduction path according to the sense result form the voltage sensing unit 114, and calculates the states of charge of the rechargeable battery 102, such as battery level or power consumption, according to the sense results from the current sensing unit 112 and the voltage sensing unit 114.

The conduction circuit 120 includes a first switch SW1, a second switch SW2 and a third switch SW3, wherein the first switch SW1 is coupled to the positive electrode of the rechargeable battery 102 and the first terminal T1 through the current sensing unit 112. The second switch SW2 is coupled to the negative electrode of the rechargeable battery 102 and the second terminal T2. The third switch SW3 is coupled to the first terminal T1 and the second terminal T2. The first terminal T1 and the second terminal T2 may replace the original positive and negative electrodes of the rechargeable battery to connect with external circuitries or other rechargeable batteries. In other words, the external circuitries can only connect to the rechargeable battery through the conduction circuit 120.

The conduction circuit 120 may be configured to form a first conduction path P1 and a second conduction path P2, wherein the first conduction path P1 is configured to pass through the first switch SW1, the rechargeable battery 102 and the second switch SW2, and the second conduction path P2 is configured to pass through the third switch SW3 but not the rechargeable battery 102. When the first switch SW1 and the second switch SW2 are turned on, the first conduction path P1 is conducted. When the third switch SW3 is turned on, the second conduction path P2 is conducted. The control unit 116 may selectively conduct the first conduction path P1 or the second conduction path P2 by controlling the first switch SW1, the second switch SW2 and the third switch SW3.

The control unit 116 may be configured with a first threshold value and a second threshold value which are used to compare with the battery voltage of the rechargeable battery 102, and whether or not the rechargeable battery 102 is overcharged or over-discharged is determined accordingly, wherein the first threshold value is greater than the second threshold value. The rechargeable battery 102 is overcharged when the battery voltage of the rechargeable battery 102 is greater than the first threshold value. The rechargeable battery 102 is over-discharged when the battery voltage of the rechargeable battery 102 is less than the second threshold value. When the battery voltage of the rechargeable battery 102 exceeds (is not in) the range from the first threshold value to the second threshold value (namely, greater than first threshold value or less than the threshold value), the control unit 116 conducts the second conduction path P2 and turns off the first conduction path P1, thereby avoiding to continue charge or discharge the rechargeable battery 102. In contrast, when the battery voltage of the rechargeable battery 102 is less than the first threshold value and greater than the second threshold value, the control unit 116 conducts the first conduction path P1 and does not conduct the second conduction path P2 so that the rechargeable battery 102 may continue to be charged or discharged normally.

Take the first switch SW1, the second switch SW2 and the third switch SW3 as an example, the control unit 120 may turn on the third switch SW3 and turn off the first switch SW1 and the second switch SW2 when the battery voltage of the rechargeable battery 102 is greater than the first threshold value or less than the second threshold value. The control unit 120 may turn on the first switch SW1 and the second switch SW2 and turn off the third switch SW3 when the battery voltage of the rechargeable battery 102 is less than the first threshold value and greater than the second threshold value.

It is noted that the first switch SW1, the second switch SW2 and the third switch SW3 may be implemented with NMOS transistor (N channel metal-oxide-semiconductor field-effect transistor), PMOS transistor (P channel metal-oxide-semiconductor field-effect transistor) or other switch elements, and the present invention is not limited thereto. Further, the conduction circuit 120 may be implemented with multiplexers or other switch elements, and the present invention is not limited thereto. The current sensing unit 112 is mainly used to sense the current value flowing through the rechargeable battery 102, which may be arranged at the positive electrode or the negative electrode of the rechargeable battery 102, and the present disclosure is not limited thereto, provided that the current sensing unit 112 can be arranged on the current conduction path through the rechargeable battery 102. By using the voltage sensing unit 114 and the current sensing unit 112, the control unit 116 may obtain the battery voltage of the rechargeable battery 102 and current value flowing through the rechargeable battery 102, therefore the remaining power, the output power and the charge efficiency may be calculated. The current sensing unit 112 may be deleted to reduce the cost if the above calculations are not necessary.

Additionally, the battery management circuit 100 may protect the rechargeable battery 102 from overcharging or over-discharging during charging or discharging procedures. However, after the charging or discharging procedure is complete, the control unit 120 conducts the first conduction path P1 and turns off the second conduction path P2 to return the external connection relations of the rechargeable battery 102 and functions thereof for the system or battery sets. The control unit 120 may determine whether the charging or discharging procedure is complete by sensing the current value and current direction on the second conduction path P2 or receiving a acknowledge signal from an external circuit.

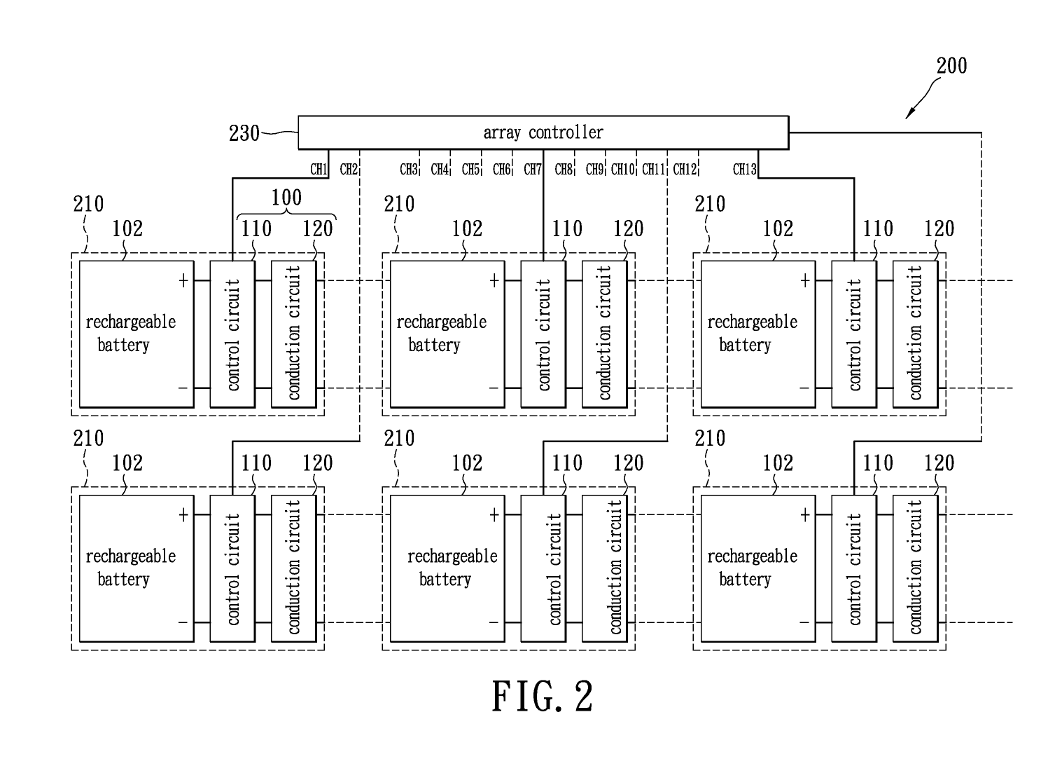

The battery management circuit 100 may be applied on rechargeable battery of battery sets to achieve the benefits of monitoring the cells individually and prevent the battery set from being damaged due to single cell damage. Refer to FIG. 1 and FIG. 2 which shows a schematic diagram of a battery module according to the first embodiment of the present disclosure. The battery module 200 is able to manage a plurality of rechargeable battery, such as one battery set or several battery sets. The battery module 200 includes a plurality of power unit 210 and an array controller 230. Each power unit 210 has a rechargeable battery 102 and a battery management circuit 100 including a control circuit 110 and a conduction circuit 120, as shown in FIG. 1. The control circuit 110 and the conduction circuit 120 are coupled to the rechargeable battery 102 for controlling the conduction paths between the rechargeable battery 102 and the external circuits. The detail circuits and operation manners with respect to the control circuit 110 and the conduction circuit 120 are described on the above-mentioned descriptions of the first exemplary embodiment, and the descriptions are omitted.

In FIG. 2, the array controller 230 may connect to the power unit 210 through a plurality of channels CH1˜CH13 respectively. The channels CH1˜CH13 and the power unit 210 are arranged one by one rather than hierarchical arrangement. Hence, the array controller 230 is directly coupled to each power unit 210 and may obtain the states of charge thereof to manage the charge/discharge paths of each power unit 210. The array controller 230 and all the management circuits 100 may form an array control circuit which is able to monitor the states of charge (including voltage and current) of all the rechargeable batteries 102 and control each conduction circuit 120 to selectively conduct the first conduction path P1 or the second conduction path P2, as shown in FIG. 1. The array controller 230 may receive the battery voltage and current value of each rechargeable battery 102 through the control circuit 110, so as to achieve the benefits of monitoring each rechargeable battery 102 individually. According to the battery voltage status of each rechargeable battery 102, the array controller 230 may determine whether or not the current conduction path of the battery module skips the rechargeable battery 102, so as to prevent any rechargeable battery 102 from being damaged due to overcharging or over-discharging. In other words, the second conduction path P2 of the conduction circuit 120 is conducted and the first conduction path P1 is not conducted, so that the charging current or the discharging current flowing through the problematic rechargeable battery 102 is avoided. The electrical information or internal configuration values obtained by the array controller 230 or the control circuit 110 may be stored in built-in or external memories, such as EEPROM (Electrically-Erasable Programmable Read-Only Memory) or flash memory, and the present disclosure is not limited thereto.

Additionally, the battery module 200 may enable the control circuit 110 to return the current conduction path between the given rechargeable battery 102 and other rechargeable batteries 102 (namely, conducting the first conduction path P1 and turning off the second conduction path P2). In another embodiment of the present disclosure, the array controller 230, the control circuit 110 and the conduction circuit 120 may be integrated in the same integrated circuit or implemented with discrete components, and the present disclosure is not limited. In FIG. 2, the array controller 230 is mainly used to integrate the electrical information of all the rechargeable batteries 102 and control the conduction circuit 120 through the control circuit 110, so as to achieve the benefits of monitoring individually.

### Second Embodiment

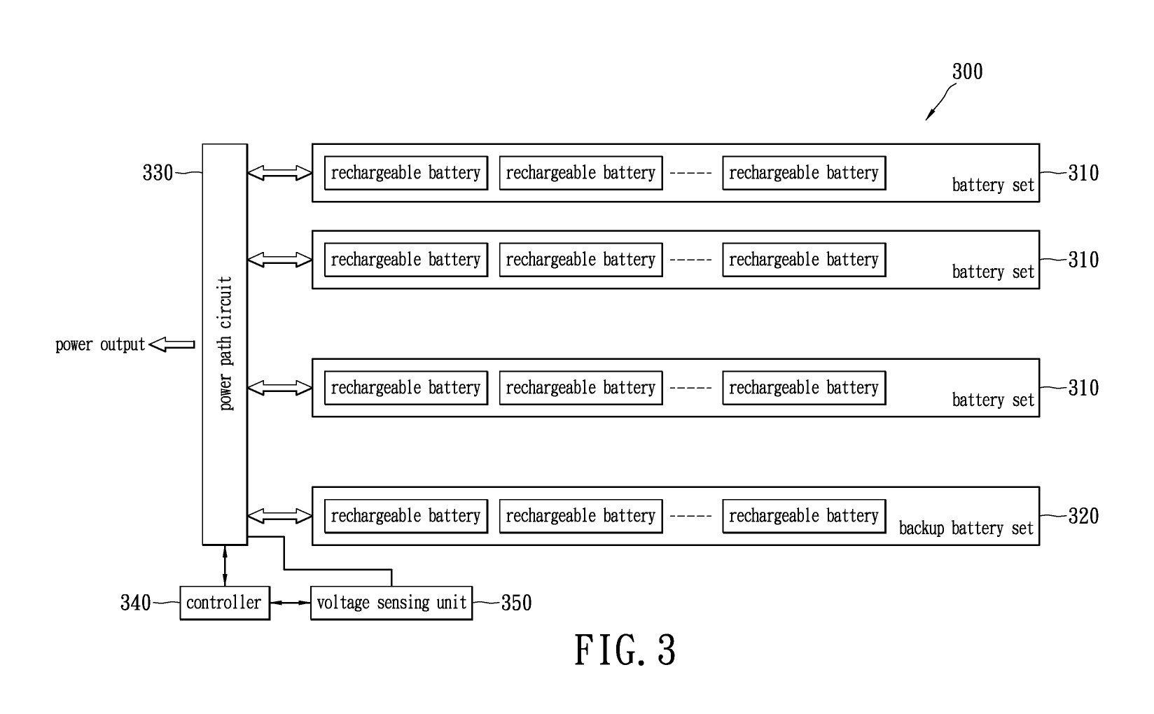

The present disclosure further provides a battery module, as depicted in FIG. 3. FIG. 3 shows a schematic diagram of a battery module according to a second embodiment of the present disclosure. The battery module 300 includes a plurality of battery sets 310, a backup battery set 320, a power path circuit 330, a controller 340 and a voltage sensing unit 350. Each of the battery sets 310 and the backup battery set 320 has a plurality of rechargeable batteries which may be connected in series or in parallel. The power path circuit 330 is coupled to all the battery sets 310 and the backup battery set 320 for switching the conduction paths of the battery sets 310 and the backup battery set 320. The voltage sensing unit 350 is coupled to the power path circuit 330 for sensing whether the voltage of the individual battery set 310 is normal. The controller 340 is coupled to the voltage sensing unit 350 and the power path circuit 330.

The controller 340 is able to determine whether or not the battery set 310 is damaged. When one of the battery sets 310 is damaged, the controller 340 may switch the conduction path between the battery sets 310 and the backup battery set 320 through the power path circuit 330 to replace the damaged battery set 310 with the backup battery set 320. The power path circuit 330 includes a circuitry for selectively coupling the battery set 310 and the backup battery set 320, which circuitry may be implemented with switches or multiplexers.

### Third Embodiment

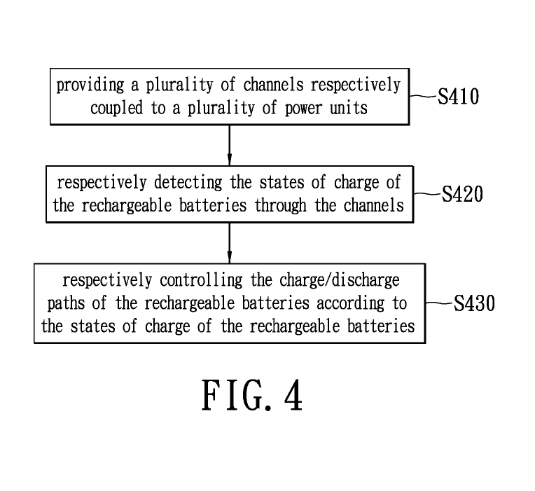

A battery management method can be derived based on preceding embodiments. Please refer to FIG. 4, which shows a flow chart of battery management method according to a third embodiment of the present disclosure. First, the method provides a plurality of channels which are coupled to a plurality of power units respectively, where each power unit has a rechargeable battery (step S410), and then the states of charge of the rechargeable batteries are detected through the channels respectively (S420). Next, the charge/discharge paths of the rechargeable batteries are respectively controlled according to the states of charge of the rechargeable batteries (S430).

In step S430, a first conduction path and a second conduction path are further provided to each rechargeable battery, wherein the first conduction path passes through the corresponding rechargeable battery and the second conduction path does not passes through the corresponding rechargeable battery. The first conduction path or the second conduction path is respectively conducted according to the battery voltage of each rechargeable battery to protect the corresponding rechargeable battery from the damage. In step S430, when the battery voltage of a first rechargeable battery of the rechargeable batteries is in a predetermined interval, the first conduction path corresponding to the first rechargeable battery is conducted and the second conduction path corresponding to the first rechargeable battery is turned off. When the battery voltage of the first rechargeable battery of the rechargeable batteries is not in (exceeds) the predetermined interval, the second conduction path corresponding to the first rechargeable battery is conducted and the first conduction path corresponding to the first rechargeable battery is turned off, wherein the predetermined interval is less than a first threshold value and greater than the second threshold value.

Those skilled in the art should be able to deduce the other details of the battery management method in the present disclosure through the above embodiments, and the detail descriptions are omitted.

Furthermore, it is noteworthy that the coupling relation between above-mentioned components includes direct or indirect electrical connections as long as electrical signal transmission may be achieved, and the present disclosure is not limited thereto. The techniques described in the above-mentioned embodiments may be combined or used independently, further the associated components may add, delete, modify or replace according to the requirements of both functional and designed, and the present invention are not limited thereto.

In summary, the current conduction paths of the battery module may be adjusted according to the state of charge (power status) of each rechargeable battery in the present invention, thereby preventing the rechargeable batteries from being overcharged or over-discharged, and causing the damage. The present invention has benefits of extending the lifetime of the battery sets and providing the battery information for the user.

The descriptions illustrated supra set forth presenting the preferred embodiments of the instant disclosure; however, the characteristics of the instant disclosure are by no means restricted thereto. All changes, alternations, or modifications conveniently considered by those skills in the art are deemed to be encompassed within the scope of the instant disclosure delineated by the following claims.

What is claimed is:

1. A battery management circuit suitable for a rechargeable battery, comprising:
a conduction circuit coupled to the rechargeable battery, the conduction circuit having a first conduction path passing through the rechargeable battery and a second conduction path without passing through the rechargeable battery; and
a control circuit coupled to the rechargeable battery and the conduction circuit for selectively conducting the first conduction path or the second conduction path of the conduction circuit according to a battery voltage of the rechargeable battery.

2. The battery management circuit according to claim 1, wherein when the battery voltage of the rechargeable battery is greater than a first threshold value, the conduction circuit conducts the second conduction path and turns off the first conduction path; when the battery voltage of the rechargeable battery is less than a second threshold value, the conduction circuit conducts the second conduction path and turns off the first conduction path; when the battery voltage of the rechargeable battery is less than the first threshold value and greater than the second threshold value, the conduction circuit conducts the first conduction path and turns off the second conduction path, wherein the first threshold value is greater than the second threshold value.

3. The battery management circuit according to claim 1, wherein the conduction circuit comprises:
a first switch coupled to a positive electrode of the rechargeable battery and a first terminal;
a second switch coupled to a negative electrode of the rechargeable battery and a second terminal; and
a third switch coupled to the first terminal and the second terminal;
wherein when the battery voltage of the rechargeable is greater than a first threshold value, the conduction circuit conducts the third switch and turns off the first switch and the second switch; when the battery voltage of the rechargeable battery is less than a second threshold value, the conduction circuit conducts the third switch and turns off the first switch and the second switch; when the battery voltage of the rechargeable battery is less than the first threshold value and greater than the second threshold value, the conduction circuit conducts the first switch and the second switch and turns off the third switch.

4. The battery management circuit according to claim 1, wherein the control circuit comprises:
a voltage sensing unit coupled to a positive electrode and a negative electrode of the rechargeable battery for sensing the battery voltage of the rechargeable battery;
a control unit coupled to the voltage sensing unit and the conduction circuit for controlling the conduction circuit to conduct the first conduction path or the second conduction path according to the battery voltage of the rechargeable battery, wherein the control circuit further comprises a current sensing unit coupled to the rechargeable battery and the control unit for sensing a current value flowing through the rechargeable battery;
wherein the control unit calculates a state of charge of the rechargeable battery according to the battery voltage and the current value flowing through the rechargeable battery.

5. A battery module, comprising:
a plurality of power units, each power unit having a rechargeable battery; and
a array controller having a plurality of channels coupled to the power units respectively, the array controller respectively detecting the states of charge of the rechargeable batteries through the channels and respectively controlling the charge/discharge paths of the rechargeable battery according to the states of charge of the rechargeable batteries.

6. The battery module according to claim 5, wherein each power unit has a battery management circuit coupled to the rechargeable battery, the battery management circuit comprising:
a conduction circuit coupled to the rechargeable battery, the conduction circuit having a first conduction path passing through the rechargeable battery and a second conduction path without passing through the rechargeable battery; and
a control circuit coupled to the rechargeable battery and the conduction circuit for selectively conducting the first conduction path or the second conduction path of the conduction circuit according to a battery voltage of the rechargeable battery.

7. The battery module according to claim 6, wherein when the battery voltage of the rechargeable battery is greater than a first threshold value, the conduction circuit conducts the second conduction path and turns off the first conduction path; when the battery voltage of the rechargeable battery is less than a second threshold value, the conduction circuit conducts the second conduction path and turns off the first conduction path; when the battery voltage of the rechargeable battery is less than the first threshold value and greater than the second threshold value, the conduction circuit conducts the first conduction path and turns off the second conduction path, wherein the first threshold value is greater than the second threshold value.

8. The battery module according to claim 6, wherein the conduction circuit comprises:
a first switch coupled to a positive terminal of the rechargeable battery and a first terminal;
a second switch coupled to a negative terminal of the rechargeable battery and a second terminal; and
a third switch coupled to the first terminal and the second terminal;
wherein when the battery voltage of the rechargeable battery is greater than a first threshold value, the conduction circuit conducts the third switch and turns off the first switch and the second switch; when the battery voltage of the rechargeable battery is less than a second threshold value, the conduction circuit conducts the third switch and turns off the first switch and the second switch; when the battery voltage of the rechargeable battery is less than the first threshold value and greater than the second threshold value, the conduction circuit conducts the first switch and the second switch and turns off the third switch, wherein the first threshold value is greater than the second threshold value.

9. The battery module according to claim 6, wherein the control circuit comprises:
a voltage sensing unit coupled to a positive electrode and a negative electrode of the rechargeable battery for sensing the battery voltage of the rechargeable battery;
a control unit coupled to the voltage sensing unit and the conduction circuit for controlling the conduction circuit to conduct the first conduction path or the second conduction path according to the battery voltage of the rechargeable battery, wherein the control circuit further comprises a current sensing unit coupled to the rechargeable battery and the control unit for sensing a current value flowing through the rechargeable battery;
wherein the control unit calculates a state of charge of the rechargeable battery according to the battery voltage and a current value flowing through the rechargeable battery.

10. A battery module, comprising:
a plurality of battery sets, each battery set having a plurality of rechargeable batteries;
a backup battery set having a plurality of rechargeable batteries;
a power path circuit coupled to the battery sets and the backup battery set for switching conduction paths of the battery sets and the backup battery set;
a voltage sensing unit coupled to the power path circuit for sensing whether the battery voltages of the battery sets are normal; and
a controller coupled to the voltage sensing unit and the power path circuit;
wherein the controller determines whether the battery sets are damaged according to a sense result from the voltage sensing unit, when one of the battery sets is damaged, the controller adjusts the conduction paths of the battery sets and the backup battery set through the power path circuit to replace the damaged battery set with the backup battery set.

11. A battery management method, comprising:
a. providing a plurality of channels respectively coupled to a plurality of power units, each power unit having a rechargeable battery;
b. respectively detecting states of charge of the rechargeable batteries through the channels; and
c. respectively controlling the charge/discharge paths of the rechargeable batteries according to the states of charge of the rechargeable batteries.

12. The battery management method according to claim 11, wherein the step c further comprises:
respectively providing a first conduction path and a second conduction path to each rechargeable battery, wherein the first conduction path passing through the corresponding rechargeable battery and the second conduction path is configured without passing through the corresponding rechargeable battery; and
selectively conducting the first conduction path or the second conduction path of each rechargeable battery according to a battery voltage of each rechargeable battery to protect each rechargeable battery from damage.

13. The battery management method according to claim 12, wherein when a battery voltage of a first rechargeable battery of the rechargeable batteries is in a predetermined interval, the first conduction path corresponding to the first rechargeable battery is conducted and the second conduction path corresponding to the first rechargeable battery is turned off; when the battery voltage the first rechargeable battery of the rechargeable batteries is not in the predetermined interval, the second conduction path corresponding to the first rechargeable battery is conducted and the first conduction path corresponding to the first rechargeable battery is turned off, wherein the predetermined interval is less than a first threshold value and greater than the second threshold value.
